(19) United States
(12) Patent Application Publication
(10) Pub. No.: US 2013/0009432 A1
(43) Pub. Date: Jan. 10, 2013

(54) DOUBLE-LOCK RECLINING SEAT FOR VEHICLE

(75) Inventor: Takayuki Inoue, Tochigi (JP)

(73) Assignee: TS TECH CO., LTD., ASAKA-SHI, SAITAMA (JP)

(21) Appl. No.: 13/637,103

(22) PCT Filed: Mar. 31, 2011
(86) PCT No.: PCT/JP2011/058254

§ 371 Date: Sep. 25, 2012

(30) Foreign Application Priority Data
Mar. 31, 2010 (JP) 2010-084526

(51) Int. Cl. B60N 2/42; B60N 2/22

(52) U.S. Cl. 297/216.13

(57) ABSTRACT

In a double-lock reclining seat, there is provided a mechanism for preventing two reclining lock mechanisms from being unlocked due to a collision load applied from a baggage or the like, without deforming the reclining lock mechanisms themselves, for example, without bending a connecting shaft of the two reclining lock mechanisms, or without adding any complicated mechanism changes to the interior of the reclining lock mechanisms. The double-lock reclining seat includes a load receiver 10 is fixed onto the connection shaft 5 of the two reclining lock mechanisms so as to extend obliquely downward from the rear side thereof, so that, as the load is applied to the back portion of the seat back from the baggage or the like, the load receiver 10 holds the connecting shaft 5 in a direction in which the two reclining lock mechanisms are locked.

### TECHNICAL FIELD

The present invention relates to a double-lock reclining seat for a vehicle which includes two reclining lock mechanisms respectively provided in the both sides thereof for adjusting the inclination angle of the seat back of the seat.

### BACKGROUND ART

For example, a know reclining lock mechanism (patent reference 1) is assembled in the following manner: that is, a disk-shaped housing and a disk-shaped cover plate having circular inner gear teeth on the outer peripheral wall thereof are combined so as to be rotatable with each other, plural lock gears are provided within the housing so as to be each removably engageable with the inner gear teeth of the cover plate, a cam for moving the lock gears is mounted centrally of the lock gears, and an operation shaft projecting laterally from the cam is inserted into the central portion of the housing and the central portion of the cover plate.

This reclining lock mechanism (lock mechanism) is provided as double lock mechanisms which are respectively assembled to the both sides of the seat by fixing the housing and the cover plate to the mutually-facing side brackets of the seat back frame and seat cushion frame.

In the double-lock reclining seat, the two lock mechanisms are connected together by a connecting shaft fixed to the operation shafts of the two lock mechanisms, and an unlocking operation lever is provided on one operation shaft. To adjust the inclination angle of the seat back, the two lock mechanisms are unlocked synchronously by rotating the connecting shaft in a given direction by operating the operation lever.

In such double-lock reclining seat, when a relatively large load is applied to the seat back from behind a vehicle, the lock mechanisms may be forcibly unlocked.

For example, by braking a vehicle to halt, a heavy baggage placed backwardly of a rear seat may be caused to collide with the back portion of the seat back. When the baggage placed backwardly of the rear seat collides with the back portion of the seat back, the seat back may be pushed down forward to be thereby deformed or shifted in position. Since a wheel house and the like exist on the vehicle body side (outer side) of the seat back, the baggage may collide with the vehicle inner side (inner side) of the seat back.

When the baggage collides with the vehicle inner side of the seat back, the seat back may be twistingly rotated forwardly from the shoulder portion of the vehicle inner side. Due to this, the vehicle inner side lock mechanism, integrally with the seat back, may be rotated about the operation shaft in its forwardly falling-down direction and thus the connection shaft may be rotated in linking with this, whereby the vehicle body side lock mechanism may be unlocked.

Conventionally, as measures to prevent the unlocking of the lock mechanism due to a load applied from a baggage or the like, the connection portion of one of the two operation shafts and the connecting shaft is structured to be bent in a dogleg manner when a load is applied from behind the seat back, so that, even when the connecting shaft is rotated integrally with the one lock mechanism, the rotation force of the connecting shaft can prevented from being transmitted to the other lock mechanism (patent reference 2).

### PRIOR ART TECHNOLOGY REFERENCE

### Patent Reference

[Patent Reference 1] JP-H08-253063-A
[Patent Reference 2] WO-2007-026571-A

### DISCLOSURE OF THE INVENTION

### Problems that the Invention is to Solve

In the above-mentioned structure, the connecting portion of the one operation shaft and the connecting shaft which can be bent in a dogleg manner corresponds substantially to the lower back of an occupant. Therefore, depending on the bent state of the connecting shaft, the seating feeling of the occupant may be worsened.

Thus, it is an object of the invention to provide measures to prevent a reclining lock mechanism from being unlocked due to a collision load applied from a baggage or the like without deforming the reclining lock mechanism itself such as bending the connecting shaft or without adding complicated mechanism changes to the interior of the reclining lock mechanism.

### Means for Solving the Problems

Aspect 1 provides a double-lock reclining seat for a vehicle, including: a seat back frame; a seat cushion frame; two reclining lock mechanisms being respectively interposed between mutually-facing side brackets of the seat back frame and the seat cushion frame at both sides of the seat; and a connecting shaft being connected to operation shafts of the two reclining lock mechanisms, wherein, to adjust an inclination angle of the seat back, the two reclining lock mechanisms are synchronously unlocked by rotating the connecting shaft in a given direction using an operation lever provided on one of the operation shafts, and wherein the seat further includes a load receiver being fixed to the rear side of the connecting shaft and extending obliquely downward therefrom to thereby receive a load applied to a back portion of the seat back from a baggage or the like, so that the load receiver holds the connecting shaft in a direction in which the two reclining lock mechanisms are locked by receiving the load applied to the back portion of the seat back from the baggage or the like.

Aspect 2 provides, based on Aspect 1, the double-lock reclining seat, further including:

a hold member being plastically deformable by receiving the load applied to the back portion of the seat back from the baggage or the like, being fixed to a lower rear side of the seat back frame which is situated higher than the connecting shaft, and extending obliquely downward therefrom toward the load receiver, so that the hold member holds the load receiver as the load is applied to the back portion of the seat back from the baggage or the like.

Aspect 3 provides, based on Aspect 2, the double-lock reclining seat, wherein the hold member has a fragile portion for plastic deformation formed in a mounting base portion thereof.

Aspect 4 provides, based on Aspect 1, the double-lock reclining seat, further including: a metal bar having a U-like shape, being plastically deformable by receiving the load applied to the back portion of the seat back from the baggage or the like, being fixed to a lower rear side of the seat back frame which is situated higher than the connecting shaft at its both end portions, and extending obliquely downward from the lower rear side of the seat back frame toward the load receiver; and a metal piece being fixed to a bridge portion of the metal bar so as to rise therefrom, and having an area allowing contact with the load receiver, wherein, as the load is applied to the back portion of the seat back from the baggage or the like, the metal bar plastically deforms to thereby cause the metal piece to hold down the load receiver.

Aspect 5 provides, based on Aspect 4, the double-lock reclining seat, wherein the metal piece has a fragile portion for plastic deformation formed in a rising base portion thereof.

Aspect 6 provides, based on Aspect 4, the double-lock reclining seat, further including: in addition to the metal bar as a first metal bar, a second metal bar having a U-like shape smaller than that of the first metal bar, being plastically deformable by receiving the load applied to the back portion of the seat back from the baggage or the like, being fixed to the lower rear side of the seat back frame at its both end portions, and extending obliquely downward from the lower rear side of the seat back frame toward the metal piece so as to be situated higher than the connecting shaft, wherein, as the load is applied to the back portion of the seat back from the baggage or the like, the second metal bar holds the metal piece.

Aspect 7 provides, based on Aspect 5, the double-lock reclining seat, wherein the second metal bar has a fragile portion for plastic deformation formed in a mounting base portion thereof.

### Effects of the Invention

According to Aspect 1, the unlocking preventive mechanism includes the load receiver for receiving the load applied to the back portion of the seat back from the baggage or the like, the load receiver is so mounted onto the connecting shaft as to extend obliquely downward from the rear side of the connecting shaft, and the load receiver holds down the connecting shaft of the two reclining lock mechanisms in the locking direction thereof by receiving the load applied to the back portion of the seat back from the baggage or the like. Thus, even when the load is applied to the back portion of the seat back from the baggage or the like, the load receiver prevents the two reclining lock mechanisms from rotating in the unlocking direction thereof, thereby retaining the reclining lock mechanisms in their locked conditions.

According to Aspect 2, the unlocking preventive mechanism further includes the plastically-deformable hold member being fixed to the lower rear side of the seat back frame which is situated higher than the connecting shaft, and extending obliquely downward therefrom toward the load receiver, so that the hold member holds the load receiver as the load is applied to the back portion of the seat back from the baggage or the like. Thus, the load receiver prevents the connecting shaft of the two reclining lock mechanisms from rotating in the unlocking direction. Also, since the hold member prevents the load receiver against rebounding, even when the load is applied to the back portion of the seat back from the baggage or the like, the reclining lock mechanisms can be surely retained in their locked conditions.

According to Aspect 3, since the hold member has a fragile portion for plastic deformation formed in its mounting base portion, when the load is applied to the back portion of the seat back from the baggage or the like, the hold member can be instantaneously deformed plastically toward the load receiver.

According to Aspect 4, the unlocking preventive mechanism further includes: the plastically-deformable metal bar having a U-like shape, being fixed to the lower rear side of the seat back frame which is situated higher than the connecting shaft at its both end portions, and extending obliquely downward from the lower rear side of the seat back frame toward the load receiver; and the metal piece being fixed to a bridge portion of the metal bar so as to rise therefrom, and having an area allowing contact with the load receiver, so that, as the load is applied to the back portion of the seat back from the baggage or the like, the metal bar plastically deforms to thereby cause the metal piece to hold down the load receiver. Thus, the rotation of the connecting shaft of the two reclining lock mechanisms in the unlocking direction can be surely prevented by the metal piece. Also, since the metal piece prevents the load receiver against rebounding, even when the load is applied to the back portion of the seat back from the baggage or the like, the reclining lock mechanisms can be surely retained in the locked conditions.

According to Aspect 5, since the metal piece has a fragile portion for plastic deformation in its rising base portion, the metal piece can be plastically bent when it holds down the load receiver, thereby reducing an impact generated when the metal piece holds down the load receiver.

According to Aspect 6, the unlocking preventive mechanism further includes: in addition to the metal bar as the first metal bar, the plastically-deformable second metal bar having a U-like shape smaller than that of the first metal bar, being fixed to the lower rear side of the seat back frame at its both end portions, and extending obliquely downward from the lower rear side of the seat back frame toward the metal piece so as to be situated higher than the connecting shaft, so that, as the load is applied to the back portion of the seat back from the baggage or the like, the second metal bar holds the metal piece. Thus, since the plastically-bent metal piece can be received from behind by the second metal bar, the load receiver can be surely held by the metal piece.

According to Aspect 7, since the second metal bar has a fragile portion for plastic deformation formed in its mounting base portion, as the load is applied to the back portion of the seat back from the baggage or the like, the second metal bar can be instantaneously deformed plastically toward the metal piece, whereby the plastically-bent metal piece can be surely received from behind by the second metal bar.

Any one of Aspects 1 to 7 can provide a mechanism to prevent the lock mechanisms from being unlocked by the load applied from the baggage or the like, without deforming the lock mechanisms themselves, for example, without bending the connecting shaft, or without adding any complicated changes to the interior of the lock mechanisms. Other characteristics and effects of the invention are obvious from the detailed description of the following embodiments and the appended patent claims.

### BRIEF DESCRIPTION OF THE DRAWINGS

FIG. 1 perspectively illustrates a seat back frame of a seat back constituting a double-lock reclining seat for a vehicle according to the invention, from behind.

FIG. 2a perspectively illustrates an unlocking preventive mechanism for a lock mechanism according to a first embodiment of the invention.

FIG. 2b illustrates the unlocking preventive mechanism shown in FIG. 2a, from side.

FIG. 2c illustrates the operation of the unlocking preventive mechanism shown in FIG. 2a when a load is applied to the lock mechanism from a baggage.

FIG. 3a perspectively illustrates an unlocking preventive mechanism according to a second embodiment of the invention.

FIG. 3b illustrates the unlocking preventive mechanism shown in FIG. 3a, from side.

FIG. 3c illustrates the operation of the unlocking preventive mechanism shown in FIG. 3a when a load is applied to the lock mechanism from a baggage.

FIG. 4a perspectively illustrates an unlocking preventive mechanism according to a third embodiment of the invention.

FIG. 4b illustrates the unlocking preventive mechanism shown in FIG. 4a, from side.

FIG. 4c illustrates the operation of the unlocking preventive mechanism shown in FIG. 4a when a load is applied to the lock mechanism from a baggage.

FIG. 5a perspectively illustrates an unlocking preventive mechanism according to a first embodiment of the invention.

FIG. 5b illustrates the unlocking preventive mechanism shown in FIG. 5a, from side.

FIG. 5c illustrates the operation of the unlocking preventive mechanism shown in FIG. 5a when a load is applied to the lock mechanism from a baggage.

### MODE FOR CARRYING OUT THE INVENTION

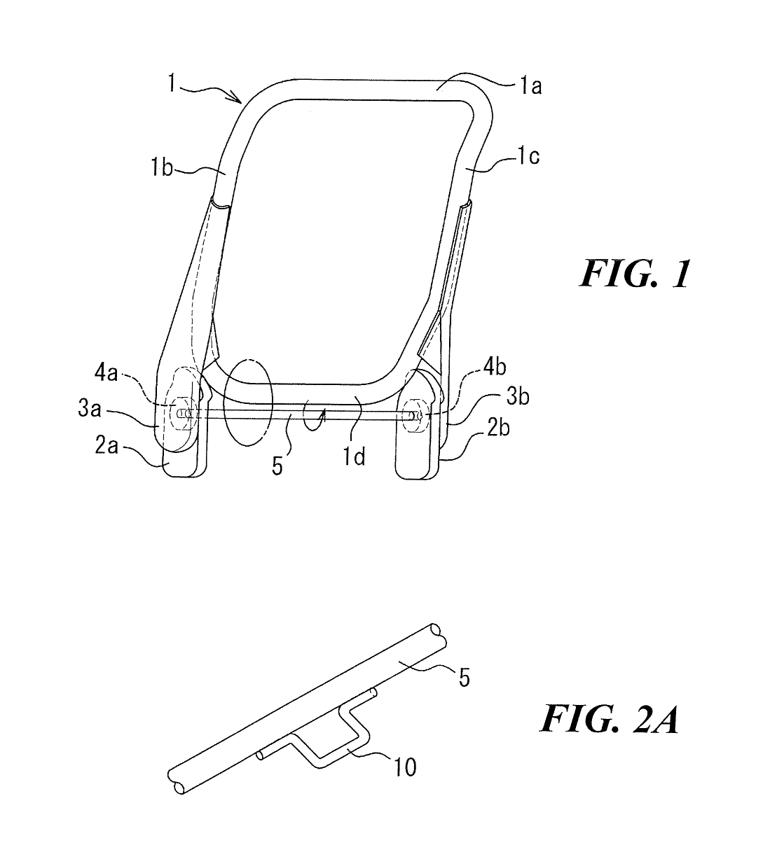

In the drawings, there is exemplified a case where a seat back frame 1 of a seat back shown in FIG. 1 includes a mechanism for preventing a reclining lock mechanism from being unlocked due to a load applied thereto from a baggage or the like. The seat back frame 1 is made of a round pipe member, and is formed into a substantially quadrilateral frame-like shape constituted of an upper frame 1a, left and right side frames 1b, 1c, and a lower frame 1d.

Side brackets 3a, 3b, which are respectively disposed to face the side brackets 2a, 2b of a seat cushion (not shown), are fixed to the lower right and left side portions of the seat back frame 1. Reclining lock mechanisms (lock mechanisms) 4a, 4b are respectively interposed between the mutually-facing side brackets 2a, 3a, 2b, 3b. The two lock mechanisms 4a, 4b are connected together by a connecting shaft 5 extended between the operation shafts (not shown) of the lock mechanisms 4a and 4b.

In the seat back frame 1, the lower frame 1d is situated higher than the connecting shaft 5, that is, the connecting shaft 5 is situated lower than the lower frame 1d. To unlock the two lock mechanisms 4a and 4b, the connecting shaft 5 is rotated in the arrow direction using an operation lever (not shown).

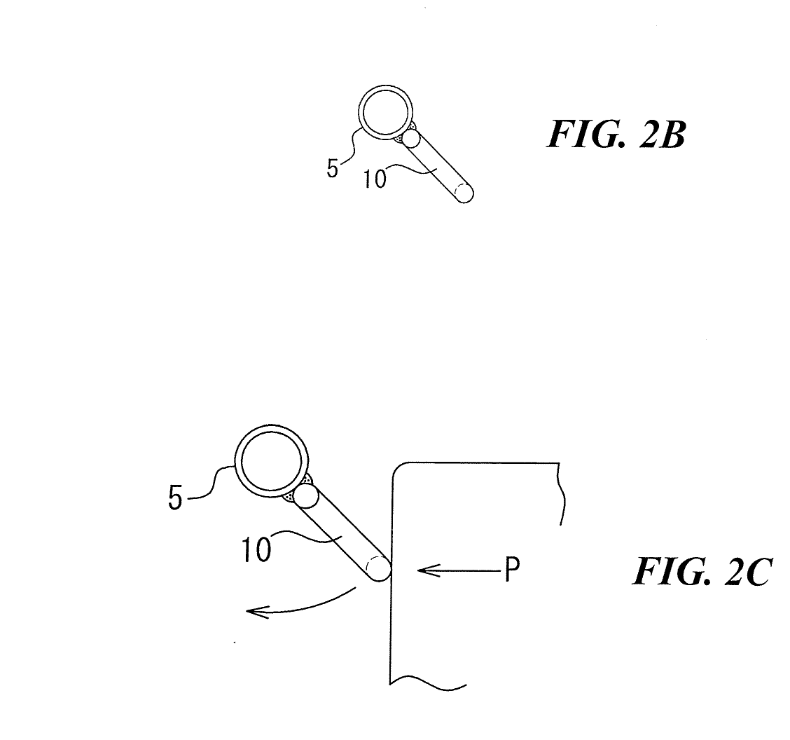

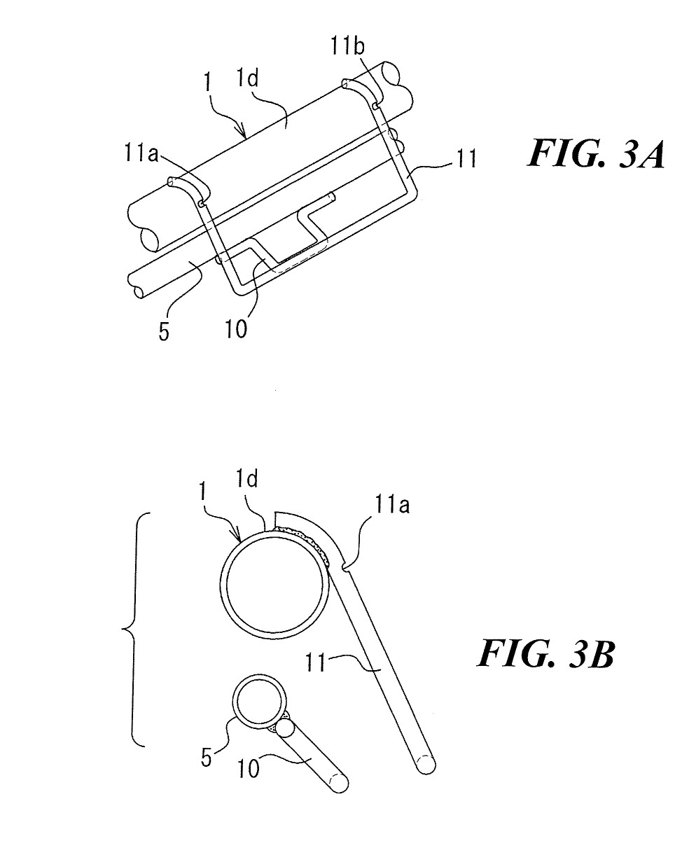

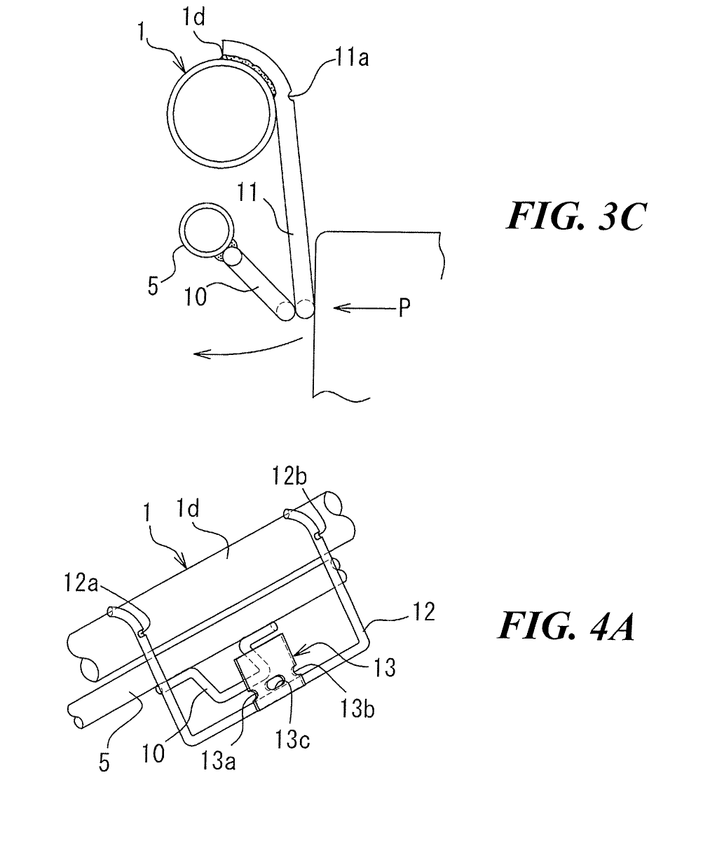

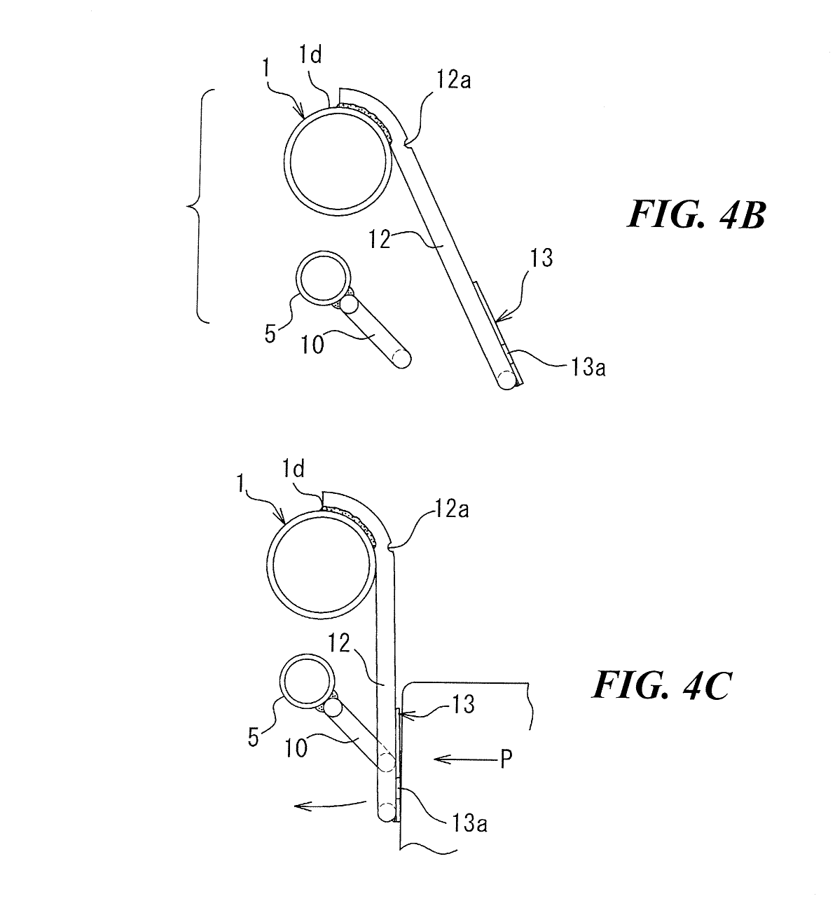

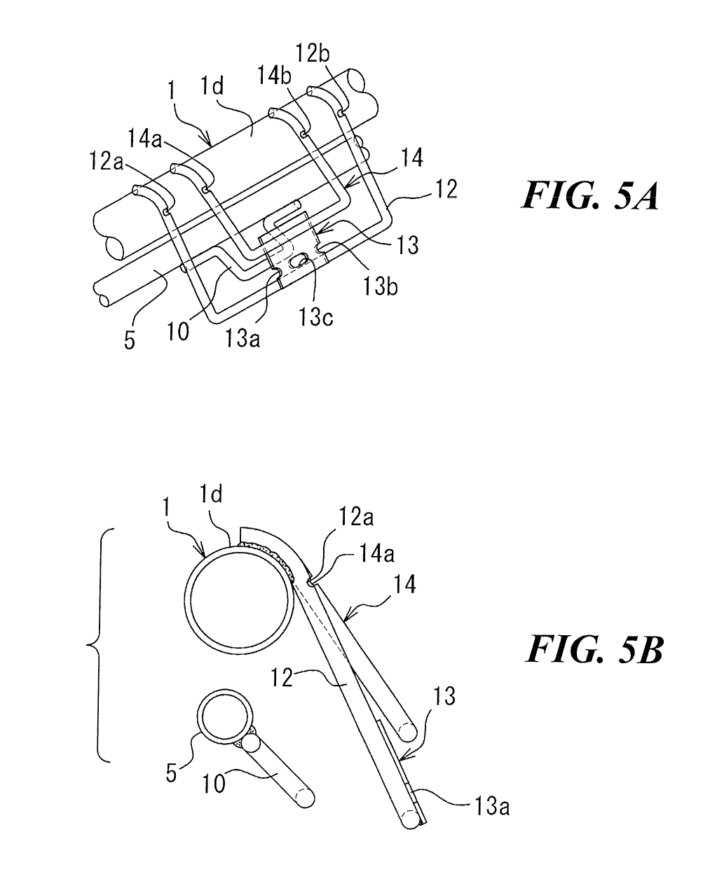

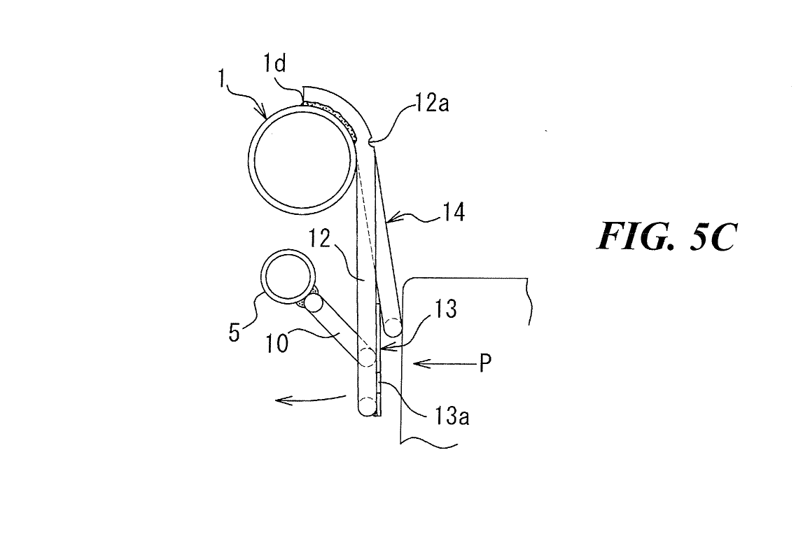

The mechanism for preventing the lock mechanisms from being unlocked due to a load applied thereto from a baggage or the like may be disposed on the axial line of the connecting shaft 5 or may be interposed between the connecting shaft 5 and lower frame 1d, on the inner side of the seat back (on the vehicle interior side surrounded by the circle shown in FIG. 1). The former corresponds to a first embodiment shown in FIGS. 2a-2c, whereas the latter corresponds to a second embodiment shown in FIGS. 3a-3c, a third embodiment shown in FIGS. 4a-4c, and a fourth embodiment shown in FIGS. 5a-5c.

According to the first embodiment, as shown in FIGS. 2a, 2b, the unlocking preventive mechanism includes a load receiver 10 for receiving a load applied to the back portion of the seat back from a baggage or the like. The load receiver 10 is formed by bending a metal bar into a substantially hat-like shape. By welding the both end portions of the load receiver 10 onto the connecting shaft 5, the load receiver 10 is mounted on the connecting shaft 5 so as to project obliquely downward from the rear side of the connecting shaft 5.

In the first embodiment, as shown in FIG. 2c, as the load P is applied to the back portion of the seat back from the baggage or the like, the load receiver 10 holds the connecting shaft 5 of the two lock mechanisms 4a, 4b in the locking direction (the opposite direction to the arrow shown in FIG. 1). When the baggage collides with the back portion of the seat back, moment in the unlocking direction is generated in the connecting shaft 5. On the other hand, as the baggage also collides with the load receiver 10, moment in the opposite direction to the unlocking direction is generated in the connecting shaft 5. Therefore, even when the load P is applied to the back portion of the seat back from the baggage or the like and the connecting shaft 5 of the two lock mechanisms 4a, 4b is caused to rotate in the unlocking direction, as the load receiver 10 also receives the load, the connecting shaft 5 is prevented from rotating in the unlocking direction, thereby retaining the lock mechanisms 4a and 4b in their locked conditions.

According to the second embodiment, as shown in FIGS. 3a, 3b, the unlocking preventive mechanism includes, in addition to the load receiver 10, a hold member 11 which can be plastically deformed when the load is applied to the back portion of the seat back from the baggage or the like. The hold member 11 is formed by bending a metal bar into a substantially U-like shape. The both end portions of the hold member 11 are welded onto the lower frame 1d, whereby the hold member 11 is mounted obliquely downward from the rear side of the lower frame 1d situated higher than the connecting shaft 5 so as to face the load receiver 10.

Alternatively, instead of forming the hold member 11 by bending a metal bar into a substantially U-like shape, the hold member 11 may also be formed of a metal plate having a width allowing contact with the load receiver 10. In this case, the upper end portion of the metal plate may be welded onto the lower frame 1d, whereby the hold member 11 can be mounted obliquely downward from the rear side of the lower frame 1d situated higher than the connecting shaft 5 so as to face the load receiver 10.

In the second embodiment, as shown in FIG. 3c, as the load P is applied to the back portion of the seat back from the baggage or the like, the load receiver 10 is held by the lower side portion of the plastically-deformed hold member 11. This enables the load receiver 10 to prevent the connecting shaft 5 of the two lock mechanisms 4a, 4b against rotation in the unlocking direction. Also, since the hold member 11 can prevent the load receiver 10 from rebounding, even when the load is applied to the back portion of the seat back from the baggage or the like, the lock mechanisms 4a, 4b can be surely retained in their locked conditions.

The hold member 11 made of a metal bar or a metal plate may include fragile portions 11a, 11b for plastic deformation respectively formed in the mounting base portions thereof. The fragile portions 11a, 11b may be grooves which are formed by partially hollowing out the shaft in a direction perpendicular to its axial direction or in the plate width direction. Due to this, as the load is applied to the back portion of the seat back from the baggage or the like, the hold member 11 can be instantaneously deformed plastically toward the load receiver 10.

According to the third embodiment, as shown in FIGS. 4a, 4b, the unlocking preventive mechanism includes, in addition to the load receiver 10, a metal bar 12 having a U-like bent shaft shape and being plastically deformable by receiving the load applied to the back portion of the seat back from the baggage or the like, and a metal piece 13 facing the load receiver 10 and having an area allowing contact with the load receiver 10. The both end portions of the U-like shape of the metal bar 12 are formed longer than those of the hold member 11 of the second embodiment.

The both end portions of the metal bar 12 are welded onto the lower frame 1d, whereby the metal bar 12 extends obliquely downward from the rear side of the lower frame 1d so as to face the load receiver 10. The lower side portion of the metal piece 13 is welded to the bridge portion of the metal bar 12, whereby the metal piece 13 stands upwardly on the metal bar 12 so as to be contacted with the load receiver 10.

In the third embodiment, as the load applied to the back portion of the seat back from the baggage or the like, as shown in FIG. 4c, the metal bar 12 is plastically deformed to press the metal piece 13 against the load receiver 10, whereby the load receiver 10 can be surely held by the metal piece 13.

In the third embodiment, the load receiver 10 to be held by the metal piece 13 prevents the connecting shaft 5 of the two lock mechanisms 4a, 4b from rotating in the unlocking direction. Also, since the metal piece 13 prevents the load receiver 10 from rebounding, even when the load is applied to the back portion of the seat back from the baggage or the like, the lock mechanisms 4a, 4b can be surely retained in their locked conditions.

In the third embodiment, the metal bar 12 may include plastically deforming fragile portions 12a, 12 in its mounting base portions, similar to those of the second embodiment. Also, the metal piece 13 may include fragile portions 13a, 13b and 13c for plastic deformation respectively formed in its rising base portion. The fragile portions 13a, 13b and 13c of the metal piece 13 may be constituted of left and right sides cutouts 13a, 13b and a central oblong hole 13c respectively formed in the metal piece 13 near the rising base portion thereof.

Thus, when the load is applied to the back portion of the seat back from the baggage or the like, the metal bar 12 can be instantaneously deformed plastically toward the load receiver 10 and the metal piece 13 can be plastically bent so as to hold the load receiver 10, whereby the metal piece 13 absorbs a load applied from the load receiver 10.

According to the fourth embodiment, as shown in FIGS. 5a, 5b, the unlocking preventive mechanism includes the metal bar 12 with the metal piece 13 fixed thereto in the third embodiment is used as a first metal bar, and a second metal bar 14 having a U-like shape smaller than the first metal bar 12 and being plastically deformable by receiving the load applied to the back portion of the seat back from the baggage or the like.

The both end portions of the second metal bar 15 are welded onto the lower frame 1d, whereby the second metal bar 14 extends obliquely downward from the rear side of the lower frame 1 d situated higher than the connecting shaft 5 and the first metal bar 12 so as to face the metal piece 13. Thus, as the load is applied to the back portion of the seat back from the baggage or the like, the second metal bar 14 receives the metal piece 13.

In the fourth embodiment, as shown in FIG. 5c, since the plastically-bent metal piece 13 can be received from behind by the second metal bar 14, the load receiver 10 can be surely held by the metal piece 13.

In the fourth embodiment, the second metal bar 14 may include fragile portions 14a, 14b for plastic deformation respectively formed in its mounting base portions. The fragile portions 14a, 14b may be grooves which are formed by partially hollowing out the shaft side surfaces of the second metal bar 14 in a direction perpendicular to the axial direction thereof. In this case, when the load is applied to the back portion of the seat back from the baggage or the like, the second metal bar 14 can be instantaneously deformed plastically toward the metal piece 13, whereby the plastically-bent metal piece 13 can be surely received from behind by the second metal bar 14.

Any one of the above-mentioned first to fourth embodiments can provide a mechanism to prevent the lock mechanisms from being unlocked due to a load applied thereto from a baggage or the like, without deforming the lock mechanisms themselves or without adding any complicated changes to the interior of the lock mechanisms.

This patent application is based on the priority declaration of the patent application No. 2010-084526 filed on Mar. 31, 2010 and thus the contents thereof are all incorporated herein for reference.

### INDUSTRIAL APPLICABILITY

The present invention provides a mechanism to prevent the lock mechanisms from being unlocked due to a load applied thereto from a baggage or the like, without deforming the lock mechanisms themselves or without adding any complicated changes to the interior of the lock mechanisms.

### DESCRIPTION OF REFERENCE NUMERALS AND SIGNS

1: Seat back frame
1d: Lower frame of seat back frame
2a, 2b: Side bracket of seat cushion frame
3a, 3b: Side bracket of seat back frame
4a, 4b: Reclining lock mechanism
5: Connecting shaft
10: Load receiver
11: Hold member
12: Metal bar (first)
13: Metal piece
13a-13c: Fragile portion
14: Metal bar (second)

1. A double-lock reclining seat for a vehicle, including:
a seat back frame;
a seat cushion frame;
two reclining lock mechanisms being respectively interposed between mutually-facing side brackets of the seat back frame and the seat cushion frame at both sides of the seat; and
a connecting shaft being connected to operation shafts of the two reclining lock mechanisms,
wherein, to adjust an inclination angle of the seat back, the two reclining lock mechanisms are synchronously unlocked by rotating the connecting shaft in a given direction using an operation lever provided on one of the operation shafts, and
wherein the seat further includes a load receiver being fixed to the rear side of the connecting shaft and extending obliquely downward therefrom to thereby receive a load applied to a back portion of the seat back from a baggage or the like, so that the load receiver holds the connecting shaft in a direction in which the two reclining lock mechanisms are locked by receiving the load applied to the back portion of the seat back from the baggage or the like.

2. The double-lock reclining seat of claim 1, further including:
a hold member being plastically deformable by receiving the load applied to the back portion of the seat back from the baggage or the like, being fixed to a lower rear side of the seat back frame which is situated higher than the connecting shaft, and extending obliquely downward therefrom toward the load receiver, so that the hold member holds the load receiver as the load is applied to the back portion of the seat back from the baggage or the like.

3. The double-lock reclining seat of claim 2,
wherein the hold member has a fragile portion for plastic deformation formed in a mounting base portion thereof.

4. The double-lock reclining seat of claim 1, further including:
a metal bar having a U-like shape, being plastically deformable by receiving the load applied to the back portion of the seat back from the baggage or the like, being fixed to a lower rear side of the seat back frame which is situated higher than the connecting shaft at its both end portions, and extending obliquely downward from the lower rear side of the seat back frame toward the load receiver; and
a metal piece being fixed to a bridge portion of the metal bar so as to rise therefrom, and having an area allowing contact with the load receiver,
wherein, as the load is applied to the back portion of the seat back from the baggage or the like, the metal bar plastically deforms to thereby cause the metal piece to hold down the load receiver.

5. The double-lock reclining seat of claim 4,
wherein the metal piece has a fragile portion for plastic deformation formed in a rising base portion thereof.

6. The double-lock reclining seat of claim 4, further including:
in addition to the metal bar as a first metal bar,
a second metal bar having a U-like shape smaller than that of the first metal bar, being plastically deformable by receiving the load applied to the back portion of the seat back from the baggage or the like, being fixed to the lower rear side of the seat back frame at its both end portions, and extending obliquely downward from the lower rear side of the seat back frame toward the metal piece so as to be situated higher than the connecting shaft,
wherein, as the load is applied to the back portion of the seat back from the baggage or the like, the second metal bar holds the metal piece.

7. The double-lock reclining seat of claim 6,
wherein the second metal bar has a fragile portion for plastic deformation formed in a mounting base portion thereof.
